(19) United States
(12) Patent Application Publication
(10) Pub. No.: US 2005/0178913 A1
(43) Pub. Date: Aug. 18, 2005

(54) Modification design for the improvement of slow flying aircraft's wing

(76) Inventor: Yin-Chi Lee, Tainan City (TW)

Correspondence Address: Yin-Chi Lee;No. 2, Alley 492, Hai Tian Rd. Sec. 2, Tainan City, TW

(21) Appl. No.: 10/747,513

(22) Filed: Dec. 30, 2003

(51) Int. Cl. B64C 1/00

(52) U.S. Cl. 244/123

(57) ABSTRACT

Modification design for the improvement of slow flying aircraft's wing comprises three major parts: a wing frame, a plastic layer and a meshwork layer. The wing frame is made according to the prior art design of conventional aircraft. The plastic layer has openings with moveable flexible plastic covering plates. The meshwork layer consists of horizontal and vertical netting.

### BACKGROUND OF THE INVENTION

My invention relates to “Modification design for the improvement of slow flying aircraft's wing”. It comprises inner wing frame and valve layer and meshwork layer. The inner wing frame is made of regular material used in prior art. The meshwork layer consists of lines of horizontal and vertical nettings. My invention focuses on the valve layer, which consists of several lines of blades and valves. The valve layer functions to delay sudden collapse, when aircraft hit by wind shear the blades turn to close after open; in reaction of the wind's resist. My invention increase the safety of the slow flying aircraft.

Conventional wing of slow flying aircraft such as glider and hang-glider and ultra-light plane is made of fiberglass or coating-canvas, which makes main body of the wing weatherproof and windproof. The wind shear in the high altitude mountain area makes the slow flying aircrafts unstable; especially when wind shear hitting the main body of the wing directly from the top of the wing. Slow flying aircraft is easy to tumble or crash down whenever hit by the wind shear that makes the aeronaut and pilot lost their lives.

### SUMMARY OF THE INVENTION

The objective of the present invention is to provide a mechanism to increase the aviation safety for slow flying aircraft.

The present invention “Modification design for the improvement of slow flying aircraft's wing” comprises three major parts: inner wing frame layer and meshwork and valve layer. The key mechanism of the present invention focuses on the valve layer, which consists of lines of valves and blades to against the wind shear while slow flying aircraft hit by wind shear. Those blades and valves close while hit by the wind shear; this mechanism delays the drastic falling from high altitude to avoid a deadly crash and save the pilots or aeronauts' lives.

### BRIEF DESCRIPTION OF THE DRAWING

FIG. 1 is a sectional drawing of the prior art of conventional wing;

FIG. 2 is a schematic drawing of prior art of conventional wing of slow flying aircraft surf in regular wind;

FIG. 3 is a schematic drawing of wind shear in high altitude mountain area;

FIG. 4 is a schematic drawing of wind shear hit the conventional wing made of prior art;

FIG. 5 is a three-dimensional exploded view of the present invention;

FIG. 6 is a schematic drawing of the present invention hit by wind shear;

FIG. 7 is a schematic drawing of the appearance of the present invention and sectional drawing;

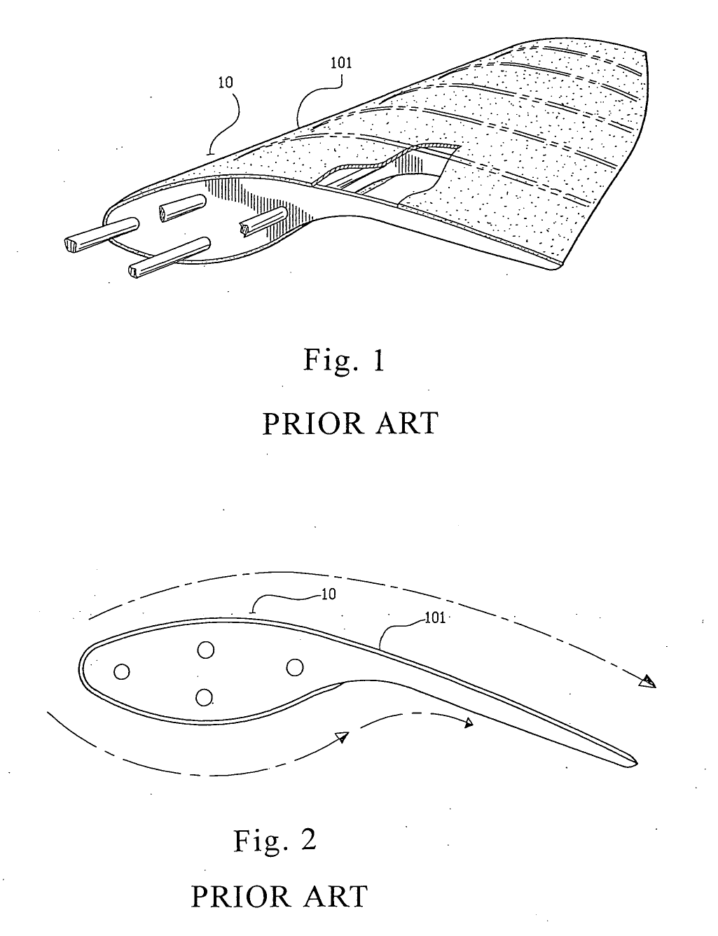

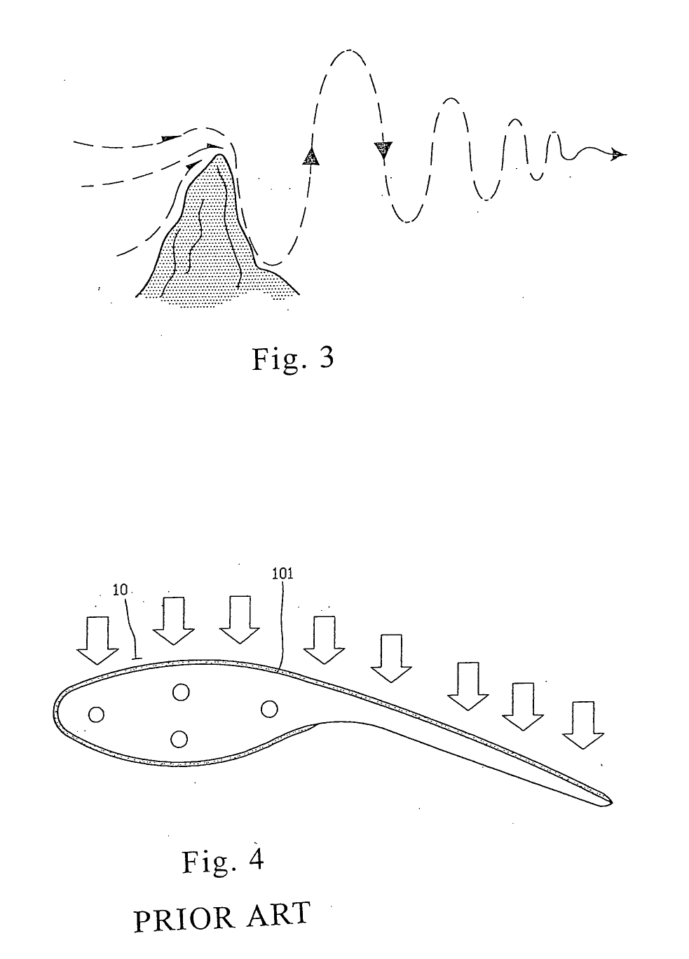

### DESCRIPTION OF THE INVENTION

Recent society more and more people take glider and ultra-light plane for recreation activity. However, some time, a pleasant surf in the sky by those conventional slow flying aircraft may turn to a tragedy while aircraft hit by wind shear; because the conventional structure of the slow flying aircraft's wing can not resist the wind shear.

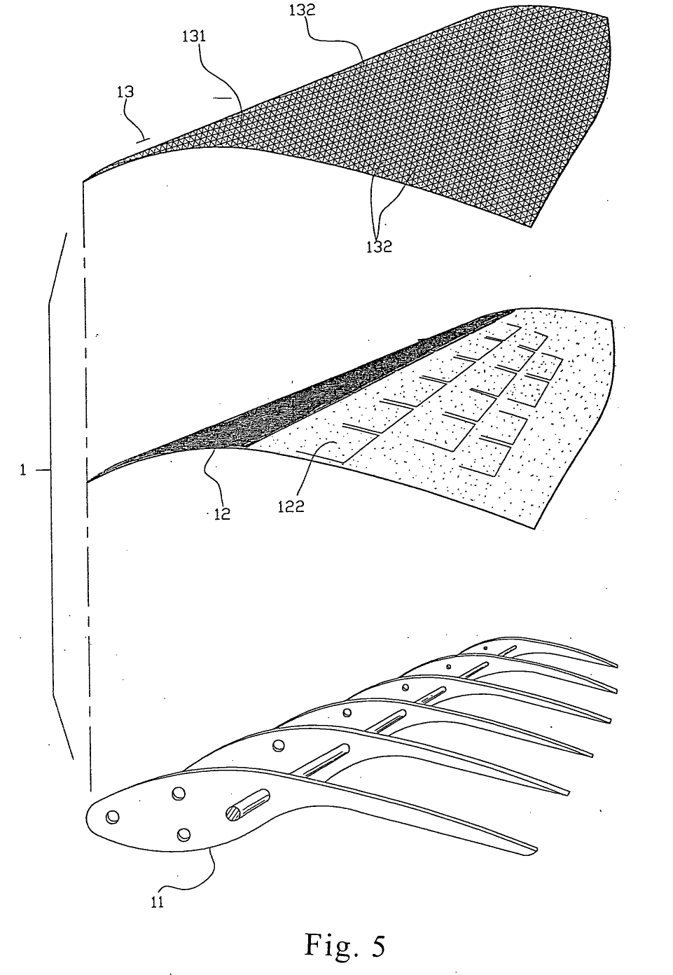

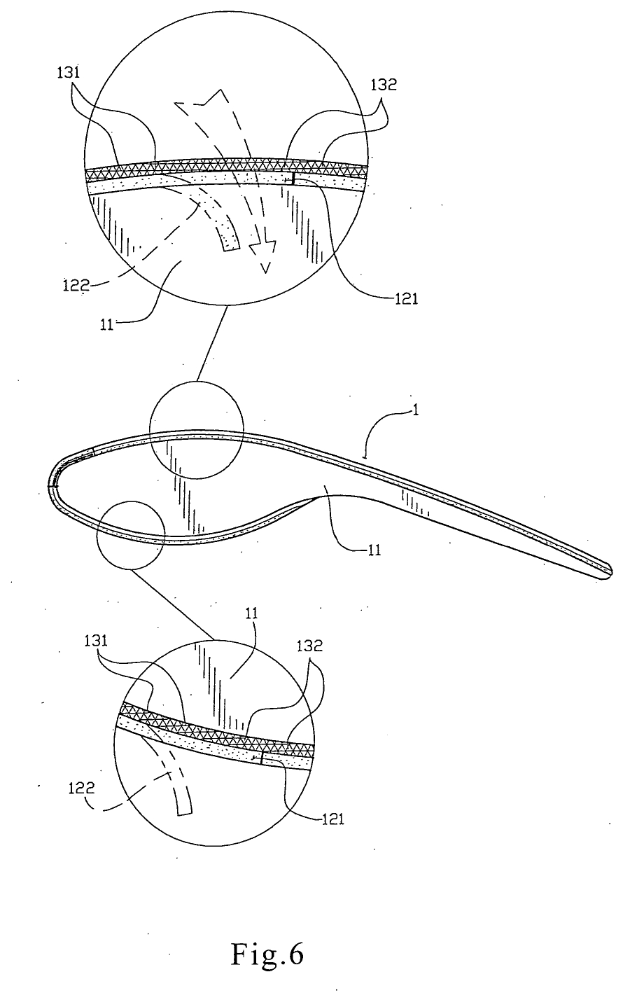

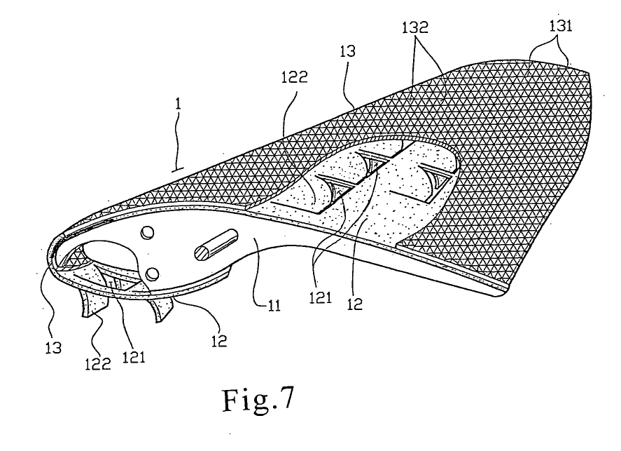

In order to against wind shear the present invention provides an improvement mechanism; referring now to the figures of the drawing in detail, particularly, to FIGS. 5 and 6 and 7, in FIG. 5, there is shown an inner wing frame (11) made of prior art and meshwork layer (13) made of several lines (131) of horizontal and vertical nettings which weave netting-holes (132); the valve layer (12) in FIG. 6, there is the key device of the present invention's mechanism which consists of valves (121) and blades (122) which made of cloth or plastic plate. As 'shown in FIG. 7, there is a whole construct of the present invention.

More specifically, on the top of the wing, the valve layer (12) covers the inner wing frame (11) then the meshwork layer (13) covers the valve layer (12); on the contrary, on the bottom of the wing, the meshwork layer (13) adhesive to the inner wing frame (11) then valve and blade layer (12) covers the meshwork layer (13) as shown in FIG. 5 and FIG. 6. Referring FIG. 6, as shown on the valve layer (12) of the bottom wing, blade (122) closes the valve (121) when aircraft hit by wind shear and valve layer (12) increases the buoyancy to decrease the hazard of crash. More than that, base on the rule of “Moving permanently moves and Static permanent is static”, the aircraft keeps on forwarding in the air even under the pressure of the wind shear because the blade (122) turns to open to let the air leak from the valve (121), though air, craft will fall but not so drastic to cause a crash; actually, the speedy of falling is lower than the wind shear. By the benefit of the law of inertia; the valves (121) both on the top and bottom keep on opening and closing while hit by wind shear, and that makes aircraft stay and surf in the air steady more long while hit by the wind shear. With the present invention, slow flying aircraft is much more safer than the conventional prior art when hit by wind shear.

In addition to, blade (122) is made of smaller plastic plate that make the valve (121) easy to open and close. The blade (122) keeps on the activity of opening and closing the valve (121) while aircraft hit by wind shear that makes the speed of falling slower than the wind shear; it delays the falling to avoid a aircraft crash.

The present invention applies not only to the wing of glider or ultra-light-plane but also helicopter's aileron. When the leading edge shuts down or ill-functions; aileron delays the drastic falling to avoid crash.

1. Modification design for the improvement of slow flying aircraft's wing comprises inner wing frame and valve layer and meshwork;
inner wing frame is made of material that is the same as conventional aircrafts wing;
meshwork layer consists of lines of horizontal and vertical nettings;
valve layer of several lines of blades and valves;

2. According claim 1; the blade of the valve layer is made of flexible plastic plate;
